(19) United States
(12) Patent Application Publication
(10) Pub. No.: US 2002/0156672 A1
(43) Pub. Date: Oct. 24, 2002

(54) Providing integrated scheduling and management of services

(76) Inventor: Benjamin Burko, Montreal (CA)

Correspondence Address: KIRTON AND MCCONKIE, 1800 EAGLE GATE TOWER, 60 EAST SOUTH TEMPLE, P O BOX 45120, SALT LAKE CITY, UT, 84145-0120, US

(21) Appl. No.: 10/098,301

(22) Filed: Mar. 15, 2002

Related U.S. Application Data
(60) Provisional application No. 60/276,528, filed on Mar. 16, 2001.

(51) Int. Cl. G06F 17/60

(52) U.S. Cl. 705/9

(57) ABSTRACT

Systems and methods for providing integrated scheduling and management of services that are provided to a customer by a professional. A system is provided that allows a customer to accesses a website in his/her own language to selectively obtain information, provide information, and/or to schedule, modify or manage an appointment. The scheduling of an appointment includes utilizing a pre-established rule-based system to prioritize appointments. The system interfaces with the customer or the professional to schedule or manage appointments. Further, the system manages information and automates record keeping and billing procedures. Instructions are provided to the customer in his/her preferred language and a reminder may be given to the customer by the system via traditional mail, telephone, or email. A variety of icons are selectively used to notify the professional of information relating to a particular customer or appointment.

### RELATED APPLICATIONS

This application claims priority to U.S. Provisional Patent Application Serial No. 60/276,528 filed Mar. 16, 2001 titled METHOD FOR INTEGRATED SCHEDULING.

### BACKGROUND OF THE INVENTION

1. Field of the Invention

The present invention relates to integrated scheduling. More particularly, the present invention relates to systems and methods for providing integrated scheduling and management of services that are provided to a customer by a professional.

2. Background and Related Art

The quality of patient care has been jeopardized by health care facilities for a variety of reasons. One reason relates to the struggle that health care facilities currently face in meeting high overhead costs, causing available budgets and resource allocations to be drastically reduced. Accordingly, a particular health care facility may not be fully staffed with the necessary numbers of physicians, nurses, and staff to support the system. Furthermore, health care facilities are unable to collect monies owed for services rendered due to uninsured patients, billing errors, and inaccurate information.

Another reason for a decline in patient care relates to reduced numbers of staff. The reception staff is typically the front line interface between care providers and the patients, and often bears the largest burden in dealing with patient frustrations and concerns. When experienced reception staff leave their places of employment an already precarious and stressful situation typically becomes worse, as retraining replacement personnel can be a long and resource intense process.

Another reason for the decline in the quality of patient care relates to the scheduling of patient appointments. Despite being a service-oriented industry, the limited number of reception staff available for interface with patients can cause the scheduling of appointments to be a time consuming process. For example, in a hospital-based ambulatory clinic setting it can take up to two weeks in order to secure an appointment by telephone for a medical visit. Furthermore, the reception staff may not enforce scheduling rules when scheduling appointments, resulting in appointment times being overbooked and an increase in the amount of time patients are required to wait for their appointments. Moreover, overbooking of appointments has restricted the ability of physicians to provide personal attention to patients and to easily make changes in their schedules.

Another reason for the decline in the quality of patient care relates to the patients themselves. At times patients do not arrive for scheduled appointments, thus preventing other patients from visiting the facility at that time. Also, patients come unprepared to appointments, causing the appointments to last longer. At times the patients speak a foreign language, and so it is difficult for the reception staff to schedule appointments and to prepare the patients for the appointments due to language barriers.

In sum, the quality of patient care is declining in the health care industry for a variety of reasons. Accordingly, it would be an improvement in the art to augment or even replace the techniques that are currently employed with other techniques to increase the quality of care that may be provided to patients.

### SUMMARY OF THE INVENTION

The present invention relates to integrated scheduling. More particularly, the present invention relates to systems and methods for providing integrated scheduling and management of services that are provided to a customer by a professional.

While the methods and processes of the present invention have proven to be particularly useful in the health care industry, those skilled in the art will appreciate that the methods and processes can be used in a variety of different applications and in a variety of industries to yield an increased ability to schedule professional services and to better manage the services rendered.

Implementation of the present invention takes place in association with a computer device and/or system that is used to integrate the scheduling and management of services received by a patient or customer. In one implementation, a customer accesses a website in his/her own language to selectively schedule, modify, or manage an appointment, and may selectively obtain or update information at the website. The scheduling of an appointment includes utilizing a pre-established rule-based system that uses factors to prioritize appointments, such as information relating to the customer, the urgency of the appointment, and other types of factors.

The customer selects the professional with whom an appointment is desired and suggests a desired appointment time to the system. The system then determines if that time is available for the professional and either schedules the appointment or presents a variety of other related times to the customer for selection. Instructions relating to the appointment are provided to the customer, in his/her preferred language, and a reminder is scheduled for delivery via traditional mail, telephone or email.

When the professional needs to modify or adjust a particular block of time of his/her schedule, the customers that are scheduled for that block of time are notified of the need to reschedule and the system interfaces with the customers to reschedule the appointment.

At the appointment, the customer may check in with a computer device or kiosk at the professional's office to indicate to the professional that the customer has arrived. The professional may selectively access information from the system relating to the customer or selectively update information managed by the system. In a further implementation, the accessing of information from the system includes obtaining a variety of icons that quickly inform the professional of specific information, such as whether or not the customer has arrived at the facility, the type of visit, and other useful information.

Accordingly, the systems and methods of the present invention provide integrated scheduling and management of services that are provided to a customer by a professional. These and other features and advantages of the present invention will be set forth or will become more fully apparent in the description that follows and in the appended claims. The features and advantages may be realized and obtained by means of the instruments and combinations particularly pointed out in the appended claims. Furthermore, the features and advantages of the invention may be learned by the practice of the invention or will be obvious from the description, as set forth hereinafter.

### BRIEF DESCRIPTION OF THE DRAWINGS

In order that the manner in which the above recited and other features and advantages of the present invention are obtained, a more particular description of the invention will be rendered by reference to specific embodiments thereof, which are illustrated in the appended drawings. Understanding that the drawings depict only typical embodiments of the present invention and are not, therefore, to be considered as limiting the scope of the invention, the present invention will be described and explained with additional specificity and detail through the use of the accompanying drawings in which:

FIG. 1 illustrates a representative system that provides a suitable operating environment for use in accordance with the present invention;

FIG. 2 illustrates a representative networked system that may be used in accordance with the present invention to integrate scheduling and manage service rendered;

FIG. 3 provides a flow chart that illustrates a representative method for systematically interacting with a customer;

FIG. 4 is a flow chart that illustrates a representative method for scheduling and managing appointments;

FIG. 5 is a flow chart that illustrates a representative method for providing interaction with a customer at a kiosk;

FIG. 6 is a flow chart that illustrates a representative method for providing interaction with a professional; and

FIG. 7 provides a representative user interface that facilitates the communication of the information to a professional.

### DETAILED DESCRIPTION OF THE INVENTION

The present invention relates to integrated scheduling. More particularly, the present invention relates to systems and methods for providing integrated scheduling and management of services that are provided to a customer by a professional.

The methods and processes of the present invention are particularly useful in the health care industry. However, those skilled in the art will appreciate that the systems and methods of the present invention embrace a variety of different applications and industries to yield an increased ability to schedule professional services and to better manage the services rendered. Accordingly, in the disclosure and in the claims the term “professional” shall refer to doctors, nurses, lawyers, mechanics, dentists, instructors, assistants, coaches, tutors, trainers, guides, clergy, repairmen, marketers, artists, plumbers, contractors, and any other service providers, or from whom time or a service may be desired. Also, in the disclosure and in the claims the term “customer” shall refer to patients, clients, shoppers, buyers, patrons, consumers, and any other receiver of a service or engager of a professional.

Embodiments of the present invention take place in association with a computer device and/or system that is used to integrate the scheduling and management of services received by a customer. Accordingly, the following disclosure of the present invention is grouped into two subheadings, namely “Exemplary Operating Environment” and “Scheduling and Managing Services.” The utilization of the subheadings is for convenience of the reader only and is not to be construed as limiting in any sense.

### Exemplary Operating Environment

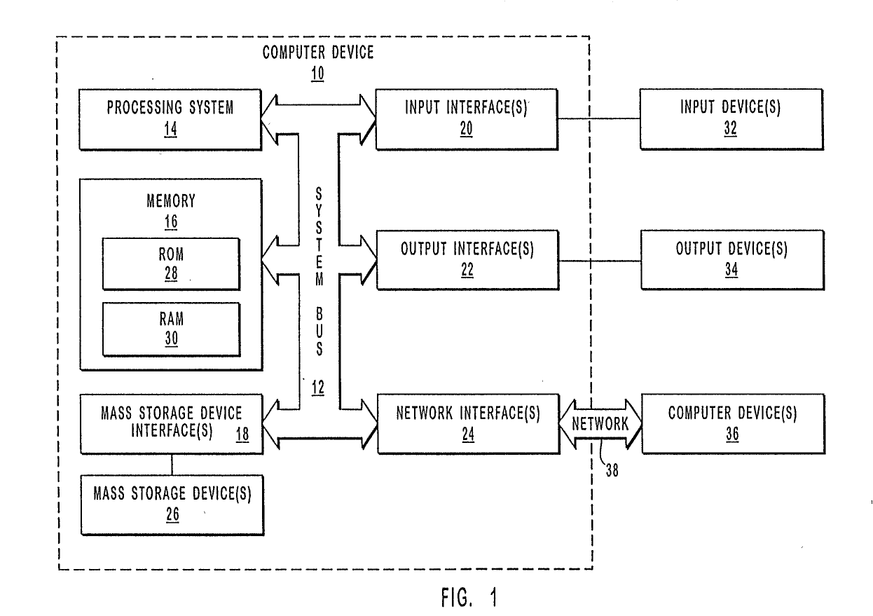

FIG. 1 and the corresponding discussion are intended to provide a general description of a suitable operating environment for the implementation of providing integrated scheduling and management of services. One skilled in the art will appreciate that the invention may be practiced by one or more computing devices and in a variety of system configurations, including in a networked configuration.

Embodiments of the present invention embrace one or more computer readable media, wherein each medium may be configured to include or includes thereon data or computer executable instructions for manipulating data. The computer executable instructions include data structures, objects, programs, routines, or other program modules that may be accessed by a processing system, such as one associated with a general-purpose computer capable of performing various different functions or one associated with a special-purpose computer capable of performing a limited number of functions. Computer executable instructions cause the processing system to perform a particular function or group of functions and are examples of program code means for implementing steps for methods disclosed herein. Furthermore, a particular sequence of the executable instructions provides an example of corresponding acts that may be used to implement such steps. Examples of computer readable media include random-access memory (“RAM”), read-only memory (“ROM”), programmable read-only memory (“PROM”), erasable programmable read-only memory (“EPROM”), electrically erasable programmable read-only memory (“EEPROM”), compact disk read-only memory (“CD-ROM”), or any other device or component that is capable of providing data or executable instructions that may be accessed by a processing system.

With reference to FIG. 1, a representative system for implementing integrated scheduling and management of services includes computer device 10, which may be a general-purpose or special-purpose computer. For example, computer device 10 may be a personal computer, a notebook computer, a personal digital assistant (“PDA”) or other handheld device, a workstation, a minicomputer, a mainframe, a supercomputer, a multi-processor system, a network computer, a processor-based consumer electronic device, or the like.

Computer device 10 includes system bus 12, which may be configured to connect various components thereof and enables data to be exchanged between two or more components. System bus 12 may include one of a variety of bus structures including a memory bus or memory controller, a peripheral bus, or a local bus that uses any of a variety of bus architectures. Typical components connected by system bus 12 include processing system 14 and memory 16. Other components may include one or more mass storage device interfaces 18, input interfaces 20, output interfaces 22, and/or network interfaces 24, each of which will be discussed below.

Processing system 14 includes one or more processors, such as a central processor and optionally one or more other processors designed to perform a particular function or task. It is typically processing system 14 that executes the instructions provided on computer readable media, such as on memory 16, a magnetic hard disk, a removable magnetic disk, a magnetic cassette, an optical disk, or from a communication connection, which may also be viewed as a computer readable medium.

Memory 16 includes one or more computer readable media that may be configured to include or includes thereon data or instructions for manipulating data, and may be accessed by processing system 14 through system bus 12. Memory 16 may include, for example, ROM 28, used to permanently store information, and/or RAM 30, used to temporarily store information. ROM 28 may include a basic input/output system (“BIOS”) having one or more routines that are used to establish communication, such as during start-up of computer device 10. RAM 30 may include one or more program modules, such as one or more operating systems, application programs, and/or program data.

One or more mass storage device interfaces 18 may be used to connect one or more mass storage devices 26 to system bus 12. The mass storage devices 26 may be incorporated into or may be peripheral to computer device 10 and allow computer device 10 to retain large amounts of data. Optionally, one or more of the mass storage devices 26 may be removable from computer device 10. Examples of mass storage devices include hard disk drives, magnetic disk drives, tape drives and optical disk drives. A mass storage device 26 may read from and/or write to a magnetic hard disk, a removable magnetic disk, a magnetic cassette, an optical disk, or another computer readable medium. Mass storage devices 26 and their corresponding computer readable media provide nonvolatile storage of data and/or executable instructions that may include one or more program modules such as an operating system, one or more application programs, other program modules, or program data. Such executable instructions are examples of program code means for implementing steps for methods disclosed herein.

One or more input interfaces 20 may be employed to enable a user to enter data and/or instructions to computer device 10 through one or more corresponding input devices 32. Examples of such input devices include a keyboard and alternate input devices, such as a mouse, trackball, light pen, stylus, or other pointing device, a microphone, a joystick, a game pad, a satellite dish, a scanner, a camcorder, a digital camera, and the like. Similarly, examples of input interfaces 20 that may be used to connect input devices 32 to the system bus 12 include a serial port, a parallel port, a game port, a universal serial bus (“USB”), a firewire (IEEE 1394), or another interface.

One or more output interfaces 22 may be employed to connect one or more corresponding output devices 34 to system bus 12. Examples of output devices include a monitor or display screen, a speaker, a printer, and the like. A particular output device 34 may be integrated with or peripheral to computer device 10. Examples of output interfaces include a video adapter, an audio adapter, a parallel port, and the like.

One or more network interfaces 24 enable computer device 10 to exchange information with one or more other local or remote computer devices, illustrated as computer devices 36, via a network 38 that may include hardwired and/or wireless links. Examples of network interfaces include a browser or other application, a network adapter for connection to a local area network (“LAN”) or a modem, wireless link, or other adapter for connection to a wide area network (“WAN”), such as the Internet. The network interface 24 may be incorporated with or peripheral to computer device 10. In a networked system, accessible program modules or portions thereof may be stored in a remote memory storage device. Furthermore, in a networked system computer device 10 may participate in a distributed computing environment, where functions or tasks are performed by a plurality of networked computer devices.

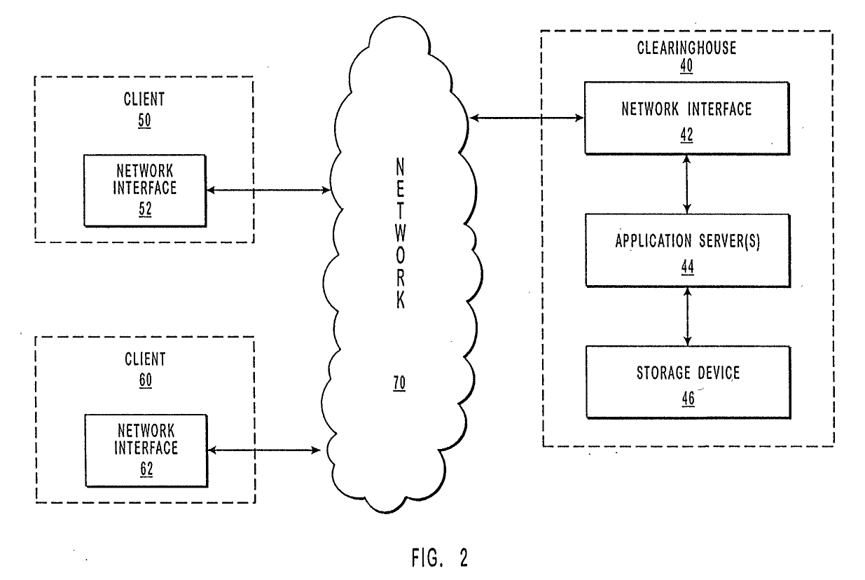

While those skilled in the art will appreciate that the invention may be practiced in networked computing environments with many types of computer system configurations, FIG. 2 represents an embodiment of the present invention that enables the providing of integrated scheduling and management of services. While FIG. 2 illustrates an embodiment that includes two clients connected to the network, alternative embodiments include one client connected to a network or more than two clients connected to a network.

In FIG. 2, clearinghouse 40 represents a system configuration that includes one or more servers that are used to provide integrated scheduling and management of services. By way of example, clearinghouse 40 may be a single server in cases where a single server can process and preserve the entire amount of information required to perform the methods of the present invention that are disclosed herein. Alternatively, clearinghouse 40 may be a conglomeration of servers that process and preserve a high volume of information.

In accordance with the illustrated embodiment, a customer may accesses a website in his/her own language to selectively schedule, modify, or manage an appointment, and may selectively obtain or update information at the website. Alternatively, embodiments of the present invention embrace the use of an agent, another individual or device that may be used to access information, modify information, or schedule an appointment on behalf of a customer.

The following is a discussion of the illustrated embodiment of the present invention, which includes a plurality of clients, illustrated as clients 50 and 60, connected to clearinghouse 40 across network 70 in order to provide integrated scheduling and management of services that are provided to a customer by a professional. Network 70 may include a wireless network, a local area network, and/or a wide area network.

With reference to FIG. 2, clients 50 and 60 include a network interface (respectively illustrated as network interfaces 52 and 62), such as a web browser or other network interface. Network interface 52 is a communication mechanism that allows client 50 to communicate with clearinghouse 40 via a network 70, such as the Internet, and to display information in the form of a web page on a display device at client 50. A browser allows for a uniform resource locator (“URL”) or an electronic link to be used to access the web page. Therefore, clients 50 and 60 may independently access a web page that enables the exchange of information with clearinghouse 40.

Clearinghouse 40 includes network interface 42, application servers 44, and storage device 46. Network interface 42 is a communication mechanism that allows clearinghouse 40 to communicate with one or more clients by via network 70. Application servers 44 include one or more servers for processing and/or preserving information, and may be employed for providing and maintaining a web page that may be accessed by a client. Storage device 46 includes one or more storage devices for preserving information, such as scheduling information, professional information, customer information, billing information, or the like to perform the methods enclosed herein. Storage device 46 may be internal or external to application servers 44.

Thus, a customer or a representative thereof at one of the clients, such as client 50, may access a web page maintained by one or more of the application servers 44 and access/submit information or schedule an appointment with a professional. Similarly, a professional or staff member at one of the clients may access/submit information or modify an appointment. Also, a third-party entity at one of the clients may access/submit information, such as billing information. While the discussion above has presented a representative system configuration for implementing the present invention, those skilled in the art will appreciate that the methods of the present invention and processes thereof may be implemented in a variety of system configurations.

### Scheduling and Managing Services

As provided above, embodiments of the present invention takes place in association with a computer device and/or system that is used to integrate the scheduling and management of services received by a patient or customer. In one implementation, a customer uses a computer device to access the system in order to selectively schedule, modify, or manage an appointment, and may selectively obtain or update information at the system.

At least some of the embodiments of the present invention embrace a web-based, rules-based, self-service scheduling system whereby customers may schedule appointments with professionals. As such, time and resources may be more effectively managed. While the following example relates to a web-based system, those skilled in the art will appreciate that the methods and processes of the present may be implemented on non-web based configurations.

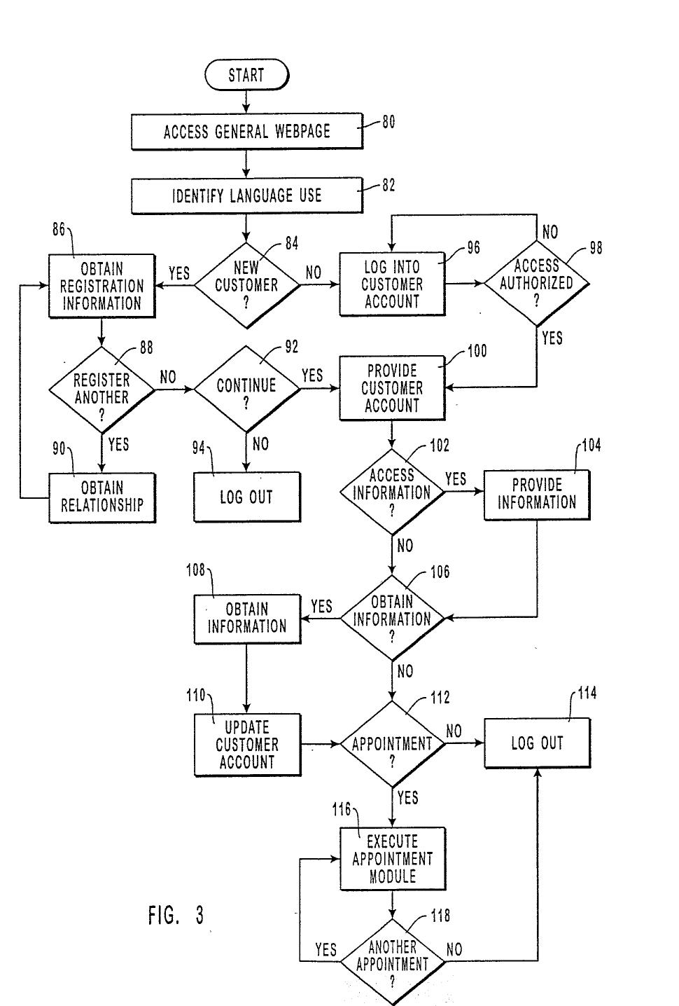

With reference now to FIG. 3, a flow chart is illustrated that provides a representative method for systematically interacting with a customer. In FIG. 3, execution begins at step 80, where a customer accesses a general website, such as by selecting an electronic link or otherwise using a uniform resource locator (“URL”). At step 82, the type of language that is to be used is identified. For example, the website may allow the customer to select the type of language that will be used when interfacing with the customer. Therefore, each customer may interface with the system of the present invention in his/her native tongue. Execution then proceeds to decision block 84 in order to determine whether or not the customer is a new customer.

If it is determined at decision block 84 that the customer is a new customer, execution proceeds to step 86, where registration information is obtained from the new customer. Registration information may include, for example, the customer's name and contact information, such as his/her address, email address, telephone number, etc. The registration information may also include information relating to the service, such as preferences, billing information, insurance information, or any other useful information. A determination is then made at decision block 88 as to whether or not to register another customer. For example, embodiments of the present invention allow for the registration of dependents or other individuals, and may associate the customers by relationships (e.g., by families). Thus, a parent may register as a customer and also register his/her spouse and children as customers. Therefore, if it is determined at decision block 88 that another customer is to be registered, execution proceeds to step 90 to obtain the relationship between a first customer and a subsequent customer. Execution then proceeds to step 86 to obtain registration information on the subsequent customer and then to decision block 88 for a determination as to whether or not to register another customer. This process may be followed until all of the customers of a particular association are entered and then execution proceeds to decision block 92 for a determination as to whether the customer desires to continue. If the customer desires to continue, execution proceeds to step 100, otherwise execution proceeds to step 94.

Returning back to decision block 84, if the customer is not a new customer, execution proceeds to step 96 where the customer logs into the customer's account. For example, a customer may log into or access his/her account by providing a username and password. Alternatively, a biometric identification may be provided in place of or in addition to a username and/or password. A decision is then made at decision block 98 as to whether or not the customer is authorized to access the personal account. If it is determined that the customer is not authorized to access the account, execution returns back to step 96. Alternatively, if the customer is authorized to access the account, execution proceeds to step 100.

At step 100, the customer account is provided along with a variety of options that may be performed, such as the ability to access information, provide information, schedule an appointment, modify an appointment, and the like. Therefore, at decision block 102, a determination is made as to whether or not the customer desires to access information. The information may include when an appointment is to occur, billing information, or any other information that may be useful to a customer. If it is determined that the customer desires to access information, execution proceeds to step 104, where the information is provided to the customer and then to decision block 106. Alternatively, if it is determined at decision block 102 that the customer does not desire to access information at this time, execution proceeds directly to decision block 106.

At decision block 106, a determination is made as to whether or not the customer desires to provide information or to allow the system to obtain information from the customer. For example, information may need to be updated on the system. This update may be initiated either by the system, the customer, or by another. If it is determined at decision block 106 that the information is to be obtained from the customer, execution proceeds to step 108, where the information is obtained from the customer and to step 110 where the customer account is updated. Execution then proceeds to decision block 112. Alternatively, if it is determined that information is not to be obtained from the customer at this time, then execution proceeds directly to decision block 112.

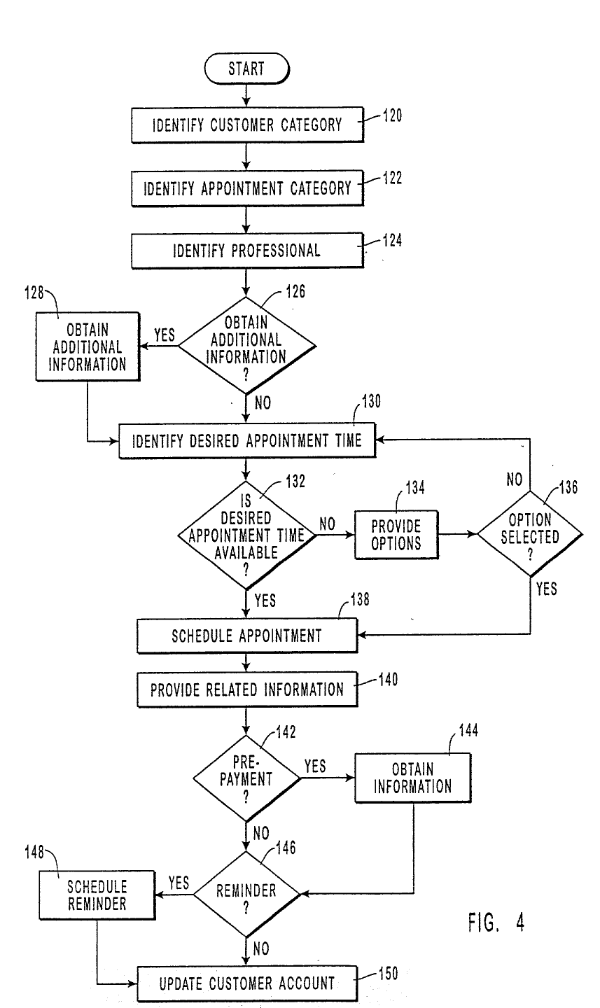

At decision block 112, a determination is made as to whether or not the customer desires to schedule or modify an appointment. A representative procedure for scheduling or modifying an appointment will be provided below in relation with FIG. 4. Thus, if it is determined at decision block 112 that the customer desires to schedule or modify an appointment, execution proceeds to step 116 where an appointment module is executed. A determination is then made at decision block 118 as to whether or not another appointment is to be modified or scheduled. If another appointment is to be modified or scheduled, execution returns back to step 116 to execute an appointment module and then back to decision block 118. Alternatively, if it is determined at decision block 112 that no appointment is to be scheduled or modified or if at decision block 118 that no other appointment is to be scheduled or modified, execution proceeds directly to step 114 to allow the customer to log out from the system.

With reference now to FIG. 4, is a flow chart is provided that illustrates a representative process that may be performed by an appointment module. The scheduling of an appointment includes utilizing a pre-established rule-based system that uses factors to prioritize appointments, such as information relating to the customer, the urgency of the appointment, and other types of factors. The customer selects the professional with whom an appointment is desired and suggests a desired appointment time to the system. The system then determines if that time is available for the professional and either schedules the appointment or presents a variety of other related times to the customer for selection. Instructions relating to the appointment are provided to the customer, in his/her preferred language, and a reminder is scheduled for delivery via traditional mail, telephone or email.

In FIG. 4, execution begins at step 120 where a customer category is identified. Information relating the customer may be obtained from the customer and/or pulled from the customer account to determine the customer category as a factor for prioritizing the appointment. For example, an immediate family member of the professional or one that has paid for a preferred status may receive a higher priority. Other customer category information may include the customer's insurance or history to pay the professional, and other such information relating to the customer that may provide for prioritization. At step 122, an appointment category is identified as a factor for prioritization. For example, in the healthcare industry, an emergency visit may be given a higher priority over a scheduled checkup. In other industries, a short deadline, the type of service being scheduled, or other information relating to the service or appointment may provide a preferred status.

At step 124, a professional is identified. In some industries the professional is fungible and so a particular location or category of professional may be selected. Alternatively, a particular professional may be desired and thus may be selected. Further, the professional may provide a service at more than one location. In such situations, the customer may select the professional and the desired location. At decision block 126, a determination is made as to whether or not to obtain additional information that may be needed to schedule the appointment, such as the reason for scheduling the appointment, the providing of a reference or referral, an indication that the appointment is being scheduled to because another appointment is being cancelled, or any other useful information. If it is determined at decision block 126 that additional information is to be obtained, execution proceeds to step 128, where the additional information is obtained and then to step 130. Alternatively, if it is determined at decision block 126 that additional information is not to be obtained, execution proceeds directly to step 130.

At step 130, the desired appointment time is identified. In one embodiment, the customer provides the desired time. In another embodiment, the professional provided the desired appointment time. A decision is then made at decision block 132 as to whether or not the desired appointment time is available. If it is determined at decision block 132 that the desired appointment time is not available, execution proceeds to step 134 to provide other options of available times in order to obtain a match between the schedule of the professional and the schedule of the customer. Examples of other options include, for example, another time on the day originally desired, the desired time on another day, the earliest available time, the closest match prior to the desired time, a time during a particular week, and the like.

A decision is then made at decision block 136 as to whether or not the customer has selected an option that was provided. If it is determined at decision block 136 that no option has been selected by the customer, execution returns back to step 130 to allow the customer to provide or otherwise identify another desired appointment time. Alternatively, if it is determined at decision block 136 that an option has been selected by the customer, execution proceeds to step 138. Returning back to decision block 132, if it is determined that the desired appointment time is available, execution proceeds directly to step 138.

At step 138 the appointment is scheduled. Information relating to the appointment is provided at step 40. Such information may include fees/costs relating to the appointment or service, anything that should be brought to the appointment, any information relating to preparation for the appointment, and other such useful information. Further, as provided above, the customer is being prepared for or informed regarding the appointment in his/her desired language. A determination is then made at decision block 142 as to whether or not a prepayment is required. For example, the customer may or may not have an insurance policy that requires a co-payment. Alternatively, a fee may be assessed for the scheduling of the appointment. If no payment is to be obtained at this time, execution proceeds to decision block 164 for a determination as to whether or not to provide a reminder.

Alternatively, if it is determined at decision block 142 that a payment is to be made, execution proceeds to step 144 to obtain information or to process the payment and then to decision block 146 for a determination as to whether or not to provide a reminder. In one embodiment, a reminder of the appointment may be provided to the customer and/or to the professional. The reminder may be automatic or scheduled. For example, the reminder of the appointment may be scheduled for a time prior to the appointment time and may be made via telephone, traditional mail, or email. If it is determined at decision block 146 that a reminder is to be provided, execution proceeds to step 148, where the reminder is scheduled and then to step 150. Alternatively, if a reminder is not to be scheduled or provided, execution proceeds directly to 150 where the customer account is updated.

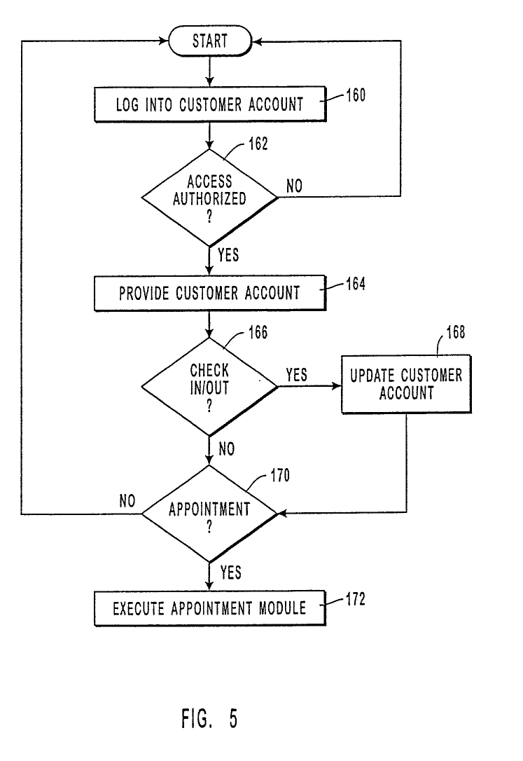

With reference now to FIG. 5, a flow chart is provided that illustrates a representative method for providing interaction with a customer at a kiosk, such as at a professional's office. In one embodiment, a kiosk replaces current reception functions for registering on-site customers upon arrival, collecting monies, and directing the customer as to where to go or how to proceed with a follow-up appointment. Thus, at the appointment, the customer may check in with a computer device or kiosk at the professional's office to indicate to the professional that the customer has arrived. A follow-up visit may be scheduled or the customer may check out from an appointment. In one embodiment, the customer checks in and checks out so that a record may be kept as to the length of time that the customer was present.

In FIG. 5, execution begins at step 160, where a customer logs into a customer account and a determination is made at decision block 162 as to whether or not access is authorized. Access may be determined by a username, password, and/or a biometric identification. If it is determined that the customer is not authorized to access the account, execution returns back to start. Alternatively, if it is determined at decision block 162 that the customer is authorized to access the account, execution proceeds to step 164, where a particular screen or customer account is provided to the customer. A determination is then made at decision block 166 as to whether or not the customer desires to check in or check out of an appointment. If it is determined at decision block 166 that the customer is checking in or checking out of an appointment, execution proceeds to step 168, where the customer account is updated and then to decision block 170. In one embodiment, a customer may check in to place his/her name on a waiting list for those who don't have an appointment. Further, those skilled in the art will appreciate that the customer may not be required to log into a personal account, but instead just provide general information to check in. Further, the check in procedure may include the registration of a new customer.

Alternatively, if it is determined at decision block 166 that the customer is not checking in or checking out from an appointment, execution proceeds to decision block 170 for a determination as to whether or not the customer desires to schedule an appointment or to modify an appointment. If it is determined at decision block 170 that the customer is not desiring to schedule or modify an appointment, execution returns back to start. Alternatively, if it is determined at decision block 170 that the customer is desiring to modify or schedule an appointment, execution proceeds to step 172, where an appointment module, such as the one discussed above in FIG. 4, is executed to allow the customer to schedule or modify an appointment.

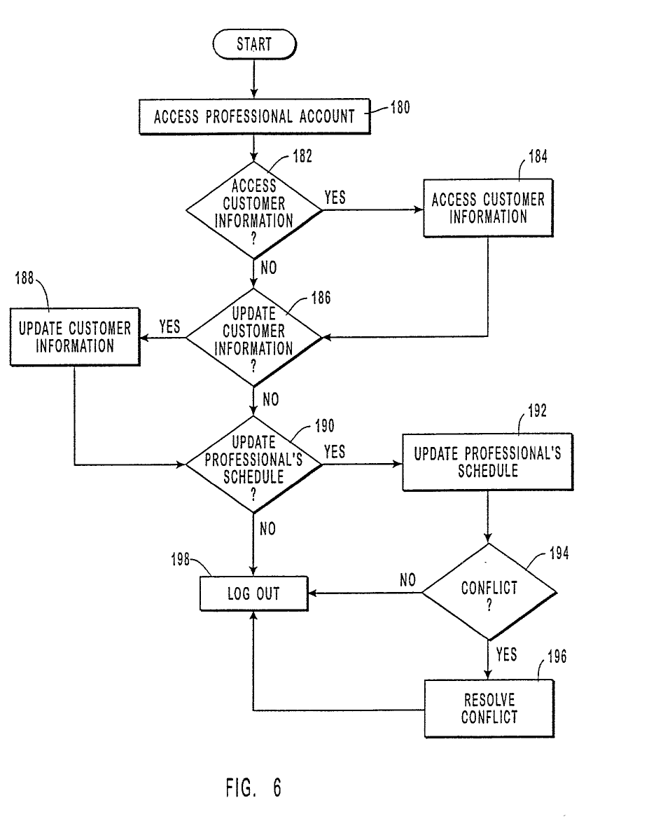

In accordance with the present invention, the professional may selectively access information from the system relating to the customer or selectively update information managed by the system. With reference to FIG. 6, a flow chart is provided that illustrates a representative method for providing interaction with a professional, such as to access information or to modify a particular block of time of the professional's schedule. When the professional modifies his/her schedule, the system works with the affected customers to reschedule appointments as needed.

In FIG. 6, execution proceeds at step 180, where a professional accesses a professional's account, such as to access information, provide a report, check a schedule, or the like. Once the account is accessed at step 180, a determination is made at step 182 as to whether or not the professional desires to access customer information. If it is determined at decision block 182 that a professional desires to access customer information, execution proceeds directly to step 184, where the professional accesses the customer information, and then to decision block 186. Alternatively, if it is determined at decision block 182 that the professional does not desire to access customer information at this time, execution proceeds directly to decision block 186.

At decision block 186, a determination is made as to whether or not the professional desires to update information relating to the customer or to the visit. If it is determined at decision block 186 that the professional desires to update information relating to the customer or to the visit, execution proceeds to step 188, where the information is updated and then to decision block 190. Alternatively, it is determined at decision block 186 that the professional does not desire to update customer information at this time, execution proceeds directly to decision block 190.

At decision block 190, a determination is made as to whether or not the professional wants to update the professional's schedule. In one embodiment, the professional may modify his/her schedule and the affected customers may be contacted by the system and an appointment rescheduled. The modification may be a permanent change (e.g., change of profession, change of location, etc.) or a temporary change (e.g., a personal vacation). Thus, if it is determined at decision block 190 that the professional desires to update the professional's schedule, execution proceeds to step 192, where the professional's schedule is updated and then to decision block 194. At decision block 194, a determination is made as to whether or not there exists a conflict. If a conflict exists, the conflict is resolved at step 196 and then execution proceeds to step 198 to allow the professional to log out. Alternatively, if it is determined at decision block 190 that the professional does not desire to update the professional's schedule or if it is determined at decision block 194 that there is no conflict, execution proceeds to step 198 to log out the professional from the professional account.

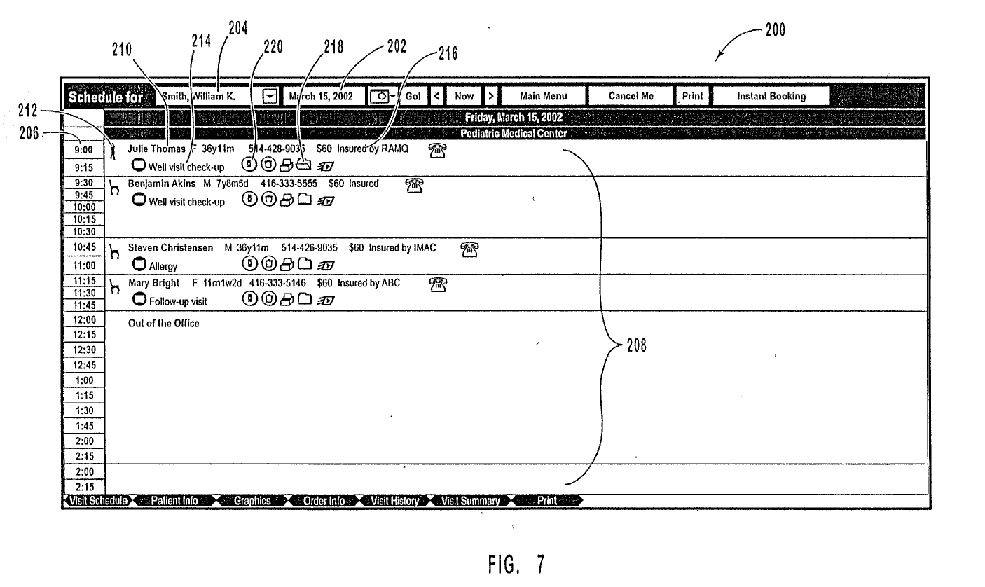

In one embodiment, the accessing of information from the system includes obtaining a variety of icons that quickly inform the professional of specific information, such as whether or not the customer has arrived at the facility, the type of visit, and other useful information. With reference to FIG. 7, a representative user interface is provided that facilitates the communication of the information to a professional.

In FIG. 7, user interface 200 includes a date 202, the identification of a professional 204, and a series of time increments 206 for the indicated date 202. The time increments 206 correspond to specific appointments 208 that have been scheduled. For example, the appointments 208 include the name 210 of the customer scheduled and information relating to the customer or to the appointment. For example, an icon 212 indicates whether or not the customer has arrived/checked in. Another icon or location 214 indicates the type or reason for the appointment. Another icon or location 216 provides billing or payment information. Icons may also be used as links to obtain additional information. For example, icon 218 provides a link to access or provide information relating to the customer's account or files. Other icons, such as icon 220, provide for a particular task to be performed, indicate special information (e.g., the customer's birthday), or any other useful information. As such, information may be quickly accessed, communicated and updated.

Those skilled in the art will appreciate that embodiments of the present invention further embrace the automation of creating and/or maintaining of the methods provided herein on a computer device or system in order to schedule and manage services. Further, embodiments of the present invention embrace interfacing with a third party, such as interfacing with an insurance company or another entity for the payment for services provided, to exchange billing information, and the like.

Thus, as discussed herein, the embodiments of the present invention embrace systems and methods for providing integrated scheduling and management of services that are provided to a customer by a professional. The present invention may be embodied in other specific forms without departing from its spirit or essential characteristics. The described embodiments are to be considered in all respects only as illustrative and not restrictive. The scope of the invention is, therefore, indicated by the appended claims rather than by the foregoing description. All changes that come within the meaning and range of equivalency of the claims are to be embraced within their scope.

What is claimed is:

1. A system that is configured to provide integrated scheduling and management of services, the system comprising:
a network;
a first computer device coupled to the network and configured to selectively schedule an appointment for a customer to receive a service from a professional;
a second computer device coupled to the network and configured to selectively access appointment information that has been scheduled, wherein the second computer device includes a display screen;
one or more icons selectively displayed on the display screen, wherein the icons communicate information relating to at least a portion of the appointment information; and
a storage device coupled to the network and configured to selectively preserve the appointment information.

2. A system as recited in claim 1, wherein the network comprises at least one of:
(i) a local area network;
(ii) a wide area network; and
(iii) a wireless network.

3. A system as recited in claim 1, further comprising a server coupled to the network, wherein the server is configured to manage the appointment information and to selectively exchange information with the first and second computer devices, and wherein the server is coupled to the storage device and preserves the appointment information on the storage device.

4. A system as recited in claim 1, wherein the information communicated by the one or more icons comprises at least one of:
(i) an arrival of the customer;
(ii) customer information; and
(iii) a reason for the appointment.

5. A system as recited in claim 1, wherein at least one of (i) the first computer device and (ii) the second computer device is located at the professional's office.

6. In a system that includes a computer device, a method for providing integrated scheduling and management of services, the method comprising the steps for:
identifying a customer and a professional, wherein the customer desires to obtain a service from the professional;
identifying one or more factors for prioritizing appointments;
selectively matching a desired appointment time with an available appointment time; and
scheduling an appointment.

7. A method as recited in claim 6, further comprising the steps for:
obtaining information associated with the customer; and
obtaining information associated with the appointment.

8. A method as recited in claim 7, further comprising the step for selectively providing access to at least one of:
(i) the information associated with the customer; and
(ii) the information associated with the appointment.

9. A method as recited in claim 6, further comprising the steps for:
determining whether the customer is a new customer; and
if the customer is a new customer, registering the customer.

10. A method as recited in claim 6, wherein the step for identifying comprises at least one of:
(i) receiving a password; and
(ii) using a biometric identification that is unique to the customer.

11. A method as recited in claim 6, wherein the one or more factors for prioritizing appointments comprise at least one of:
(i) a category for which the customer corresponds; and
(ii) a category for which the appointment corresponds.

12. A method as recited in claim 6, wherein the step for selectively matching comprises the steps for:
obtaining the desired appointment time;
determining whether the desired appointment time is available;
if the desired appointment time is not available, providing one or more alternative appointment times; and
receiving an election of one of the alternative appointment times.

13. A method as recited in claim 12, wherein the step for providing one or more alternative appointment times comprises at least one of the steps for:
(i) identifying an earliest available appointment time;
(ii) identifying an appointment time that is available on the same day as the desired appointment time;
(iii) identifying an appointment time that is available at the same time but on a different day as the desired appointment time;
(iv) identifying an available appointment time during a particular day; and
(v) identifying an available appointment time during a particular week.

14. A method as recited in claim 6, further comprising the step for providing information to the customer relating to the scheduled appointment.

15. A method as recited in claim 14, wherein the information relating to the scheduled appointment is selectively provided to the customer in a language desired by the customer.

16. A method as recited in claim 6, further comprising at least one of the steps for:
(i) tracking billing information related to the service; and
(ii) receiving a payment for the service.

17. A method as recited in claim 6, further comprising selectively providing a reminder of the appointment.

18. A method as recited in claim 6, further comprising the steps for:
receiving a request to modify the appointment; and
rescheduling the appointment.

19. A method as recited in claim 18, wherein the step for rescheduling comprises the steps for:
automatically contacting the customer when the request was performed by the professional; and
selectively matching a second desired appointment time with a second available appointment time.

20. A computer program product for implementing within a computer system a method for providing integrated scheduling and management of services, the computer program product comprising:
a computer readable medium for providing computer program code means utilized to implement the method, wherein the computer program code means is comprised of executable code for implementing the steps for:
identifying a customer and a professional, wherein the customer desires to obtain a service from the professional;
identifying one or more factors for prioritizing appointments;
selectively matching a desired appointment time with an available appointment time; and
scheduling an appointment.

21. A computer program product as recited in claim 20, wherein the executable code further implements the steps for:
determining whether the customer is a new customer; and
if the customer is a new customer, registering the customer.

22. A computer program product as recited in claim 20, wherein the step for selectively matching comprises the steps for:
obtaining the desired appointment time;
determining whether the desired appointment time is available;
if the desired appointment time is not available, providing one or more alternative appointment times; and
receiving an election of one of the alternative appointment times.

23. A computer program product as recited in claim 22, wherein the step for providing one or more alternative appointment times comprises at least one of the steps for:
(i) identifying an earliest available appointment time;
(ii) identifying an appointment time that is available on the same day as the desired appointment time;
(iii) identifying an appointment time that is available at the same time but on a different day as the desired appointment time;
(iv) identifying an available appointment time during a particular day; and
(v) identifying an available appointment time during a particular week.

24. A computer program product as recited in claim 20, wherein the executable code further implements the providing of a reminder of the appointment.

25. A computer program product as recited in claim 24, wherein the executable code further implements the steps for:
receiving a request to modify the appointment; and
automatically rescheduling the appointment by initiating a contacting with the customer when the request was performed by the professional, and selectively matching a second desired appointment time with a second available appointment time.
